(19) United States
(12) Patent Application Publication
(10) Pub. No.: US 2013/0309412 A1
(43) Pub. Date: Nov. 21, 2013

(54) UV CURABLE SELF-BONDING SILICONE RUBBER

(71) Applicant: MOMENTIVE PERFORMANCE MATERIALS INC., Waterford, NY (US)

(72) Inventors: Melvin Richard Toub, Clifton Park, NY (US); Vincent Joseph Colarossi, Melrose, NY (US)

(73) Assignee: Momentive Performance Materials Inc., Waterford, NY (US)

(21) Appl. No.: 13/886,628

(22) Filed: May 3, 2013

Related U.S. Application Data
(60) Provisional application No. 61/647,100, filed on May 15, 2012.

(51) Int. Cl. B05D 3/06

(52) U.S. Cl. CPC B05D 3/067
USPC 427/515; 427/558

(57) ABSTRACT

A method for manufacturing a composite article of polytetrafluoroethylene and silicone includes: (a) providing a UV-curable silicone: (b) applying the UV-curable silicone to a polytetrafluoroethylene backing; and (c) exposing the UV-curable silicone to UV radiation sufficient to cure the silicone.

### BACKGROUND

1. Field of the Invention

The present invention relates to the manufacture of composites of silicone and a backing material.

2. Background of the Art

Various composites of silicone and backing materials are used, for example, in the manufacture of cap liners, bottle closures, septa, and the like. Sepia are used, for example, as sealing caps for syringe vials. Typically, septa are made from natural or silicone rubber. After piercing a septum with a hypodermic needle, the rubber closes the puncture to provide an air and moisture tight seal to prevent contact between the contents of the vial and outside air or moisture.

With respect to the manufacture of septa, the conventional method is to mix thermal curing agent (peroxide or platinum) into the silicone compound; calendering the catalyzed silicone rubber onto a surface modified polytetrafluoroethylene (PTFE) sheet; rolling up the uncured, calendered silicone/PTFE composite sheet onto a hollow rigid core to form a roll; wrapping the outer surface of the roll with sheet steel or low permeability plastic film (e.g. mylar); placing the roll in a hot air oven or steam autoclave to cure the roll, removing the hot, cured roll and waiting for several hours to permit the roll to reach room temperature, removing the outer wrap from the roll; slitting the cured silicone/PTFE bonded composite into narrower rolls; then passing the slit rolls through a punch press to die cut septa of the appropriate diameter.

The conventional method is a labor and energy intensive multi-step process, which suffers from long curing times and scrap production due to out-gassing at the edges of the calendered sheets. What is needed is a simpler method of manufacturing septa and other such composites without employing a thermally cured silicone.

### SUMMARY

Provided herein is a method for manufacturing a composite article of a backing material such as, for example, polytetrafluoroethylene and silicone. The method comprises the steps of: (a) providing a UV-curable silicone; (b) applying the UV-curable silicone to a polytetrafluoroethylene backing; and (c) exposing the UV-curable silicone to UV radiation sufficient to cure the silicone.

The composite articles made in accordance with the invention include septa such as, for example, injection port septa, cap liners, cap closures, vial caps, lined seals, lined caps, and cap covers. The composite articles can be used in areas such as chromatography, environmental sampling, medical diagnostics, chemical packaging and pharmaceuticals.

### DETAILED DESCRIPTION OF PREFERRED EMBODIMENT(S)

Other than in the working examples or where otherwise indicated, all numbers expressing amounts of materials, reaction conditions, time durations, quantified properties of materials, and so forth, stated in the specification are to be understood as being modified in all instances by the term “about.”

It will also be understood that any numerical range recited herein is intended to include all sub-ranges within that range.

It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

The present invention employs a UV-curable silicone rubber made in accordance with the method and materials disclosed in U.S. Publication No. 2009/0062417 to Wrobel et al., which is herein incorporated by reference in its entirety.

In order to resolve the above mentioned problems of the prior art there has been provided a continuous process for the manufacture of continuously shaped cured silicone articles, comprising the following steps:

a) a step of providing a UV-curable silicone, comprising the combining of:
(i) at least one linear polyorganosiloxane having at least three alkenyl groups and an average number of diorganosiloxy units determined by GPC with polystyrene as standard of at least 3000,
(ii) optionally one or more polyorganosiloxane having alkenyl groups, other than the polyorganosiloxane according to the component (i),
(iii) at least one polyorganosiloxane having at least two SiH groups,
(iv) at least one photoactivatable transition metal catalyst,
(v) optionally one or more fillers,
(vi) optionally one or more conventional additives, to provide an uncured silicone.

b) optionally, modifying the surface of a backing sheet;

c) calendering the uncured silicone onto the backing sheet to provide a composite silicone/backing sheet;

d) exposing the silicone to UV radiation to photoactivate the photoactivatable transition metal catalyst.

e) optionally one or more heat treatment steps,

f) optionally one or more cutting and/or winding and/or packaging steps of the continuously shaped cured silicone article to provide the composite article.

A continuous process according to the present invention—in contrast to a batch process—relates to the manufacture of endless (continuously) shaped articles (like tubes, profiles, strands, insulations and sheets of endless articles). In an embodiment the composition can be shaped through a die as, for example, by extrusion, in contrast to an article that is discontinuously prepared by filling a mold and releasing the article from the mold after curing. However, the method of making the composite article of the present invention particularly employs calendering the catalyzed uncured composition and backing sheet between rolls to form composite sheets, which are then exposed to UV light to cure the silicone composition.

Component (i) to be used in step (a) of the process of the invention is at least one linear polydiorganosiloxane having at least three alkenyl groups and an average number of diorganosiloxy units determined by GPC (gel permeation chromatography) with polystyrene as standard of at least 3000 as number average mol weight of the linear molecules.

Preferably the linear polyorganosiloxane corresponding to component (i) has at least 5, more preferably at least 10 alkenyl groups in order to provide suitable cross-linking density.

Preferably the linear polyorganosiloxane corresponding to component (i) has a maximum number of 100 alkenyl groups, still more preferably of 50 alkenyl groups, because otherwise the reactivity of the polyorganosiloxane may decrease.

The preferred viscosity range of the polyorganosiloxane(s) (i) used according to the invention is preferably at least 1.5 kPa·s, more preferably 5 kPa·s, more preferably 10 kPa·s, more preferably 15 kPa·s (25 degrees C.; at a shear rate of 1 s⁻¹). Such a viscosity is preferred in order to achieve a suitable viscosity (green strength) of the mixture to be shaped, in particular, by calendering.

The polyorganosiloxane(s) (i) having at least three alkenyl groups may have pendant and terminal alkenyl groups. “Pendant alkenyl groups” in accordance with the present invention is intended to mean an alkenyl group of a R(alkenyl)SiO (D^{alkenyl}) or (alkenyl)SiO_{3/2} (T^{alkenyl}) group. “Terminal alkenyl groups” in accordance with the present invention is intended to mean an alkenyl group of a M^{alkenyl} group. Preferably the polyorganosiloxane(s) (i) in average have at least one pendant alkenyl group, more preferably at least two pendant alkenyl groups, still more preferably at least three pendant alkenyl groups. Most preferably polyorganosiloxane(s) (i) are used that have two terminal alkenyl groups and at least one pendant alkenyl group in addition.

The use of such polyorganosiloxane(s) (i), in particular those having at least one, preferably at least three pendant alkenyl groups, and optionally two terminal alkenyl groups in addition, in the continuous shaping, in particular, calendering process of the present invention, generally provides a sufficient cross-linking density obtained upon irradiation, i.e., satisfactory mechanical properties, like low permanent set and high recovery properties after any deformation.

The linear polyorganosiloxane (i) having at least three alkenyl groups preferably has an average number of diorganosiloxy units Pₙ determined by GPC with polystyrene as standard of at least 3000, more preferably at least 3500, more preferably at least 4000, and still more preferably 5000 to 12000. Pₙ is determined by the equation

Pₙ=(Mₙ/molecular weight of the repeating siloxy unit).

The Mₙ value is the number average molecular weight wherein the low molecular weight polyorganosiloxanes up to 10 siloxy units are not counted. These low molecular weight polyorganosiloxanes are mainly comprised of cyclic polyorganosiloxanes.

The polyorganosiloxanes (i) to be used in accordance and in particular the polyorganosiloxanes (i), having the preferred viscosity, are essentially linear, i.e. being composed of M and D units.

However, in addition to those linear polyorganosiloxanes (i) there might optionally be used low molecular branched alkenyl polyorganosiloxanes having an average number of siloxy units of about less than 1000 to a certain extent, in particular less than 30 weight-% based on the total amount of the mixture to be shaped. Such branched alkenyl polyorganosiloxanes are comprised by the definition of component (ii) described below. These low molecular low molecular branched alkenyl polyorganosiloxanes may be part of the mixture to be shaped, in order to increase cross-linking density.

The average content of the alkenyl groups in the linear polyorganosiloxane(s) (i) is preferably from about 0.02 to 1.57 mol. % Si alkenyl groups related to the number of silicon atoms in the linear polyorganosiloxane(s) (i) (corresponding to about 0.003 to about 0.21 mmol/g SiVi), more preferably from 0.08 to 0.7 mol. % (corresponding to about 0.01 to 0.095 mmol/g SiVi). The alkenyl content is determined here by way of .sup.1H NMR—see A. L. Smith (ed.): The Analytical Chemistry of Silicones, J. Wiley & Sons 1991 Vol. 112 pp. 356 et seq. in Chemical Analysis ed. by J. D. Winefordner.

The preferred polydiorganosiloxanes (i) can be described by the general formula (I):

R₍₃₋ₓ₎R¹_{z}SiO(R¹RSiO)ₙ(R₂SiO)_{b}SiR₍₃₋ₓ₎R¹ₓ (I),

in which x is preferably 0, 1, 2 or 3, preferably 1, a is an average value and is in the range of 0 to 100, preferably 1 to 50, more preferably 1 to 20, b is an average value and is in the range of 3000 to 12000, preferably 3500, more preferably 4000, and still more preferably 5000 to 11000, more preferably 6000 to 1000, with the proviso that the polydiorganosiloxanes (i) of the general formula (I) have at least three alkenyl groups.

R=a saturated organic group, preferably unsubstituted or substituted hydrocarbon radicals, more preferably n-, iso-, tert- or C₁-C₁₂-alkyl, C₁-C₁₂-alkoxy(C₁-C₁₂)alkyl, C₅-C₃₀-cycloalkyl or C₆-C₃₀-aryl, C₁-C₁₂-alkyl(C₆-C₁₀)aryl, each of these radicals R can have substitution by one or more F atoms and/or can contain one or more —O— groups.

R¹=an unsubstituted or substituted C₂-C₁₂-alkenyl radical, these preferably being selected from: unsubstituted and substituted alkenyl-containing hydrocarbon radicals, such as n-, iso-, tert-, or cyclic C₂-C₁₂-alkenyl, vinyl, allyl, hexenyl, C₆-C₃₀-cycloalkenyl, cycloalkenylalkyl, norbornenylethyl, limonenyl, C₈-C₃₀-alkenylaryl, in which, if appropriate, one or more —O— atoms can be present (corresponding to ether radicals) and the radicals can have substitution by one or more F-atoms.

Preferred examples of suitable monovalent hydrocarbon radicals R include alkyl groups, preferably CH₃, CH₃CH₂, (CH₃)₂CH, C₈H₁₇ and C₁₀H₂₁ groups, cycloaliphatic groups, such as cyclohexylethyl, aryl groups, such as phenyl, tolyl, xylyl, aralkyl groups, such as benzyl and 2-phenylethyl groups. Preferred monovalent halogenated hydrocarbon radicals R in particular have the formula CₙF₂ₙ₊₁CH₂CH₂—, where n is from 1 to 10, examples being CF₃CH₂CH₂—, C₄F₉CH₂CH₂—, and C₆F₁₃CH₂CH₂—. A preferred radical is the 3,3,3-trifluoropropyl group.

Particularly preferred radicals R include methyl, phenyl, and 3,3,3-trifluoropropyl.

Preferred radicals R¹ are groups such as vinyl, allyl, 5-hexenyl, cyclohexenylethyl, limonenyl, norbornenylethyl, ethylidenenorbornyl, and styryl, particular preference being given to vinyl.

In accordance with the invention it is possible to use a mixture of different polyorganosiloxanes (i) having different alkenyl contents, preferably vinyl contents in order to improve the mechanical properties, such as tensile strength and tear propagation resistance of the shaped crosslinked or cured silicone rubber articles.

In accordance with the present invention for example a mixture of a vinyl-rich polyorganosiloxane (I′) and a vinyl-poor polyorganosiloxane (II′) (having a lower content of vinyl groups than the vinyl-rich polyorganosiloxane) in a weight ratio of 100:0.5 to 1:10, preferably 10:1 to 1:1 may be used, in order to suitably adjust satisfactory mechanical properties, like elongation, tear strength, permanent set.

Furthermore in accordance with the present invention it is possible to use in addition to the polyorganosiloxanes (i) comprising at least three alkenyl groups, polyorganosiloxanes, which are essentially linear alkenyl-endcapped polyorganosiloxanes having one alkenyl group on each terminal siloxy group (one of the possible components (ii)). Such alkenyl polydiorganosiloxanes have two alkenyl groups and are for example of the following formula (II′):

R₂R¹SiO(R₂SiO)ₙSiR₂R¹ (II′),

in which the index ‘u’ is an average value and is in the range of 3000 to 12000, preferably 5000 to 11000, more preferably 6000 to 10000, and R and R¹ have the same meanings as given above for formula (I).

The addition of those linear alkenyl-endcapped polyorganosiloxanes having one alkenyl group on each terminal siloxy group may help in maximizing the elongation and tear strength of the cured continuously shaped silicone articles, prepared with the process of the invention.

In order to provide silicone mixtures to be shaped and cured having a good balance between cross-linking velocity and cross-linking density the alkenyl (in particular vinyl content of all polyorganosiloxane(s) in the mixture to be shaped (not only the polyorganosiloxane(s) in accordance with the definition of component (i)) should be set as high as possible, in particular, to at least 0.03 mol-% Si alkenyl (corresponding to at least 0.004 mmol/g SiVi).

At the same time, however, the content of vicinal alkenyl groups in the uncured mixture of components (i) to (vi) soluble in CDCl₃ at 25 degrees C. determined by ²⁹Si-NMR spectroscopy preferably should be less than 0.025 mol. %.

The term “vicinal alkenyl groups” used in accordance with the present invention means alkenyl groups attached to two neighboring silicon atoms.

The content of vicinal alkenyl groups in the uncured mixture of components (i) to (vi) is measured by ²⁹Si—NMR spectroscopy in accordance to Maris J. Ziemelis and J. C. Saam, presented at the 132.sup.nd Meeting Rubber Division, American Chemical Society Cleveland, Ohio Oct. 6-9, 1987.

In particular the uncured mixture of components (i) to (vi) is mixed with CDCl₃ in a weight-ratio of 30 wt-% of the uncured mixture of components (i) to (vi) and 70 wt-% of CDCl₃ with the exclusion of curing-inducing light. Thereafter the mixture is optionally centrifuged. To the resulting dispersion is 0.8 wt. % of Cr(AcAc)₃ is added, and the dispersion is subjected to ²⁹Si—NMR spectroscopy measurement.

The content of vicinal Si-alkenyl groups in the component (i) is measured in the same manner.

The method to determine the concentration of vicinal Si alkenyl groups of the uncured mixture is exemplified for the preferred vinyl groups attached to silicon atoms. The Si atoms in the ²⁹Si—NMR spectroscopy having vicinal vinyl groups as preferred embodiment of the invention have a chemical shift of −35.47 to −34.89 ppm. The molar concentration of the vicinal Si vinyl groups is thus calculated by:

Integral of the Si atoms in the range of −35.47 to −34.89 ppm/Integral over all Si atoms.times.100%.

Apart from this it is possible in the practice of the invention, in particular, in the manufacture of the mixture to be cured; to control the content of the vicinal Si alkenyl, in particular, vinyl groups, by calculating the content of the vicinal Si alkenyl groups, in particular, vinyl groups as follows:

Such method follows the equation:

(mol.%Si^{vicinal vinyl})=(mol.%Si^{vinyl}*mol.%Si^{vinyl}),

wherein Si^{vinyl} is determined as follows:

For each alkenyl containing polyorganosiloxane in the mixture the content of the vinyl groups Si^{vinyl} is determined by ¹H-NMR spectroscopy, and for each alkenyl containing polyorganosiloxane the content of the vicinal Si alkenyl groups is calculated according to the formula:

(mol.%Si^{vicinal vinyl})=(mol.%Si^{vinyl}*mol.%Si^{vinyl}).

Then the individual vicinal Si vinyl contents in mol. % are multiplied with the relative weight in % (related to the total weight of all alkenyl containing polyorganosiloxanes) of each alkenyl containing polyorganosiloxane, and the sum of all such products is divided by 100. For example, if there are three alkenyl containing polyorganosiloxane in the mixture to be cured, x1, x2 and x3, having a vicinal Si vinyl content (mol. % Si^{vicinal vinyl}) of 0.03, 0.05 and 0.1 mol. %, respectively, and a weight percentage of 20, 30 and 50 wt-%, respectively, then the Si^{vicinal vinyl} is calculated as follows:

(0.03×20+0.05×30+0.1.times.50)/100=(0.6+0.15+5)/100=0.0575 mol %.

As a first approximation the content of vicinal Si alkenyl groups calculated in this manner can be used to adjust the content of vicinal Si alkenyl groups determined by ²⁹Si-NMR-spectroscopy as explained above.

If the alkenyl content of all polyorganosiloxane(s) in the mixture to be shaped is less than 0.03 mol-% the cross-linking density may be too low to provide satisfactory mechanical properties, (i.e., the permanent set and the elongation may be too high).

If the pan of the uncured mixture of the components (i) to (vi), which is soluble in CDCl₃ at 25 degrees C., has a content of vicinal Si-alkenyl groups of more than 0.025 mol. %, then the curing rate may be too slow in order to ensure economical forming or shaping line speeds. A higher content of vicinal alkenyl groups may be possible, but, however, would require higher catalyst concentrations, which are again not desirable under economical aspects. Under certain circumstances, where an increased pot life is desired, it may be feasible, however, to adjust a total content of vicinal alkenyl groups above 0.025 mol-%.

More preferably the content of the vicinal alkenyl groups in the polyorganosiloxane (i) is less than 0.01 mol-%, and more preferred the content is less than 0.005 mol-%, still more preferred less than 0.001 mol-%.

In the present invention alkenyl-substituted polyorganosiloxanes other than the polyorganosiloxanes (i), which are referred to in this document as components(s) (ii) such as the essentially linear alkenyl-endcapped polydiorganosiloxanes having one alkenyl group on each terminal siloxy group, i.e., two alkenyl groups, described before, may be used in the mixture to be shaped in accordance with the continuous process of the invention. Such alkenyl-substituted polyorgano-siloxanes (ii) other than the polyorganosiloxane(s) (i) may include for example also those having a lower number of diorganosiloxy units than 3000.

Polyorganosiloxanes (i) with a content of the vicinal alkenyl groups of less than 0.025 mol % may be prepared by equilibration polymerization reaction using basic or acidic catalysts using both the various cyclosiloxanes, and linear polyorganosiloxanes, and also symmetrical 1,3-divinyltetramethyldisiloxane, and other relatively long-chain siloxanes having a trialkylsiloxy end cap or SiOH end groups. Examples of those used for this purpose are the hydrolysates of different alkylchlorosilanes, e.g. vinyidimethylchlorosilane and/or dimethyldichlorosilane, other examples being the trialkyl-terminated siloxanes per se obtained therefrom or these in a mixture with other siloxanes.

The required component(s) (iii) are preferably selected from linear, cyclic or branched SiH-containing polyorganosiloxanes of the general formula (III):

[Mₐ₂D_{b2}T_{c2}Q_{d2}R²ₑ₂]ₘ (III)

in which

M=R³R₂SiO_{1/2},

D=R³RSiO_{2/2},

T=R³SiO_{3/2},

Q=SiO_{4/2}, in which

R=n-, iso-, tert- or C₁-C₁₂-alkyl, C₁-C₁₂-alkoxy(C₁-C₁₂)alkyl, C₅-C₃₀-cycloalkyl or C₆-C₃₀-aryl, C₁-C₁₂-alkyl(C₆-C₁₀)aryl, each of these radicals R can have substitution by one or more fluorine atoms and/or can contain one or more —O— groups,

R³=R, R¹ or hydrogen, with the proviso that at least two radicals R³ per molecule are hydrogen, and both here can occur simultaneously in one molecule, but at least two radicals R³ per molecule are hydrogen attached to a silicon atom, R being defined above. R=methyl and R¹=vinyl, if present, being preferred.

R²=a divalent aliphatic n-, iso-, tert-, or cyclic C₁-C₁₄-alkylene radical, or a C₆-C₁₄-arylene or, respectively, alkylenearyl radical, which in each case bridges two siloxy units M, D or T,

m=from 1 to 1000

a2=from 1 to 10

b2=from 0 to 1000

c2=from 0 to 50

d2=from 0 to 1

e2=from 0 to 300.

The polyhydrogensiloxanes (iii) are preferably linear, cyclic, or branched polyorganosiloxanes whose siloxy units have advantageously been selected from M=R₃SiO_{1/2}, M^{H}=R₂HSiO_{1/2}, D=R₂SiO_{2/2}, D^{H}=RHSiO_{2/2}, T=RSiO_{3/2}, T^{H}=HSiO_{3/2}, Q=SiO_{4/2} in which these units are preferably selected from MeHSiO units and MezHSiO_{0.5} units alongside, if appropriate, other organosiloxy units, preferably dimethylsiloxy units.

The siloxy units present in the component (iii) can be linked to one another in the polymer chain, blockwise or randomly. Each siloxane unit of the polysiloxane chain can bear identical or different radicals of the group R.

The indices of the formula (III) describe the average degree of polymerization Pₙ, measured as number average Mₙ, determined by GPC (polystyrene as standard) these being based on polyhydrogenmethylsiloxane and, within the prescribed viscosity limits, is to be appropriately adjusted on the basis of siloxy groups using other substituents with other molecular weights.

The polyhydrogensiloxane (iii) in particular encompasses all of the liquid, flowable, and solid polymer structures of the formula (III) with the degrees of polymerization resulting from the indices stated above. Preference is given to the polyhydrogensiloxanes (iii) whose molar mass is smaller than about 60000 g/mol, preferably smaller than 20000 g/mol.

The preferred polyhydrogensiloxanes (iii) have structures which are selected from the group which can be described via the formula (IIIa-IIIf)

HR₂SiO(R₂SiO)_{z}(RHSiO)ₚSiR₂H (IIIa)

Me₂SiO(Me₂SiO)_{z}(MeHSiO)ₚSiMe₂H (IIIb)

Me₃SiO(Me₂SiO)_{z}(MeHSiO)ₚSiMe₃ (IIIc)

Me₃SiO(MeHSiO)ₚSiMe₃ (IIId)

{[R₂R³SiO_{1/2}]₀₋₃[R³SiO_{3/2}][R⁴O)ₙ₋₂}ₘ₂ (IIIe)

{[SiO_{4/2}][R⁴O_{1/2}]ₙ₂[R₂R³SiO_{1/2}]_{0.01-10}[R³SiO_{3/2}]₀₋₅₀[RR³SiO_{2/2}]₁₀₀₀}ₘ₂ (IIIf)

where

z=from 0 to 1000

p=from 0 to 100

z+p=b4=from 1 to 1000

n2=from 0.001 to 4

m2=from 1 to 1000

in which R⁴O_{1/2} is an alkoxy radical on silicon, and R³ is defined as above.

One preferred embodiment of the class (IIIe) and (IIIf) compound is provided by way of example by monomeric to polymeric compounds which can be described via the formula [(Me₂HSiO_{0.5})ₖSiO_{4/2}]ₘ₂ wherein k can have integer or decimal values from 0.01 to (2*m₂+2).

The concentration of SiH is preferably in the range from 0.5 to 100 mol. % related to silicon atoms, or 0.1 to 17 mmol/g based on polyhydrogen-methyl-siloxanes and, within the prescribed viscosity limits, is to be appropriately adjusted on the basis of siloxy groups using other substituents.

In one preferred embodiment of the invention, the polyorganohydrogensiloxane (iii) is composed of at least one polyorganohydrogensiloxane (iii-1) having per average two Si—H groups per molecule and of at least one polyorgano-hydrogensiloxane of type (iii-2) having more than two Si—H groups per molecule. In this embodiment, component (iii) is composed of at least two different polyorganohydrosiloxanes (iii), which produce different crosslinking structures, in order to give high-strength silicone elastomeric shaped articles. Bifunctional polyorganohydrogensiloxanes (iii-1) act as so-called chain extenders, and the polyhydrogensiloxanes (iii-2) of relatively high functionality (>2) act as crosslinking agents. The silicone composition to be shaped used according to the invention preferably comprises at least one bifunctional chain extender (iii-1) and at least one crosslinking agent (iii-2).

Examples of preferred structures of component (iii-1) in the inventive silicone rubber composition include chain extenders (iii-1) such as:

HMe₂SiO-(Me₂SiO)_{z}SiMe₂H, and

Me₃SiO-(Me₂SiO)_{z}(MeHSiO)₂SiMe₃

[(Me₂SiO)_{z}(MeHSiO)₂].

The crosslinking agents (iii-2) comprise compounds such as:

Me₃SiO-(MeHSiO)ₚSiMe₃,

HMe₂SiO(Me₂SiO)_{z}(MePhSiO)_{z}(MeHSiO)ₚSiMe₂H,

(MeHSiO)ₚ,

(HMeH₂SiO)₄Si

MeSi(OSiMe₂H)₃,

in which p and z are defined as above.

Mixtures of this type composed of what are known as chain extenders and crosslinking agents can be used by way of example as described in U.S. Pat. No. 3,697,473.

In a further preferred embodiment, the amount of components (iii-1) and (iii-2) is from 0 to 70 mol-% of (iii-1), and from 30 to 100 mol-% of (iii-2), based on (iii-1) and (iii-2).

If it is necessary to still further increase the cure rate, this can by way of example be achieved via an increase of the ratio of SiH to alkenyl, or an increased amount of catalyst (iv), or an increase in the proportion of polyorganosiloxanes (iii-2) which contain HMe₂SiO_{0.5} units.

The polyorganosiloxanes (iii) are preferably siloxane-soluble and, respectively, liquid at room temperature, i.e., preferably have fewer than 1000 siloxy units, i.e. preferably have viscosities below 40 Pa·s at 25 degrees C. and D=1 s⁻¹.

The chain length of the crosslinking agents as component (iii-2), which are mainly composed of MeHSiO units, is preferably from 3 to 200, particularly preferably being from 15 to 60 MeHSiO units.

The chain length of the chain extenders as component (iii-1), these being mainly composed of Me₂SiO units and HMe₂SiO_{1/2}, is preferably from 2 to 100, particularly preferably being from 2 to 60 Me₂SiO units.

The SiH content in the present invention is determined by way of ¹H NMR, see A. L. Smith (ed.): The Analytical Chemistry of Silicones, J. Wiley & Sons 1991 Vol. 112 pp. 356 et seq. in Chemical Analysis ed. by J. D. Winefordner.

The polyhydrogensiloxanes (iii) can be prepared by processes known per se, e.g. using acidic equilibration or condensation, as disclosed by way of example in U.S. Pat. No. 5,536,803. The polyhydrogensiloxanes (iii) can also be reaction products generated by a hydrosilylation reaction of organohydrosiloxanes using siloxanes containing smaller amounts of alkenyl groups in the presence of a hydrosilylation catalyst, where the resultant excess SiH content is preferably within the limits defined above. This gives organohydrogensiloxanes (iii) bridged by alkylene groups such as R.sup.2 groups.

The polyhydrogensiloxanes (iii) can moreover also be reaction products which have come from condensation of, for example, organohydrogenalkoxysiloxanes (iii) using hydroxy- or alkoxysilanes and, respectively, siloxanes, e.g. as described in U.S. Pat. No. 4,082,726, e.g. columns 5 and 6.

According to the invention, it is preferable to select the ratio of component (iii) to component (i) and optionally present component (ii) in such a way that the molar ratio present of Si—H to Si-alkenyl units is from about 0.5 to 20:1, preferably from 1 to 3:1.

The preferred amount of the polyhydrogensiloxanes (iii) is from 0.1 to 200 parts by weight, based on 100 parts by weight of component (i) and optionally present component (ii).

Many properties, such as vulcanizate properties, crosslinking density, stability, and surface tack, can be influenced by way of the ratio of SiH units to Si-alkenyl units.

### The Photoactivatable Catalyst Component (iv)

Component (iv), the photoactivatable catalyst, preferably contains at least one metal selected from the group composed of Pt. Pd, Rh, Co, Ni, Ir or Ru. The photoactivatable catalyst preferably comprises platinum.

Component (iv) is preferably an organometallic compound, i.e., comprises carbon-containing ligands, or salts thereof. In a preferred embodiment component (iv) has metal carbon bonds, including sigma- and pi-bonds. Preferably the photoactivatable catalyst is an organometallic complex compound having at least one metal carbon sigma bond, still more preferably a platinum complex compound having preferably one or more sigma-bonded alkyl and/or aryl group, preferably alkyl group(s). Sigma-bonded ligands include in particular, sigma-bonded alkyl groups, preferably sigma-bonded C₁ to C₆-alkyl, more preferably sigma-bonded methyl groups, sigma-bonded aryl groups, like phenyl, sigma-bonded silyl groups, like trialkyl silyl groups. Most preferred photoactivatable catalyst include η⁵-(optionally substituted)-cyclopentadienyl platinum complex compounds having sigma-bonded ligands, preferably sigma-bonded alkyl ligands.

The photoactivatable catalyst can be used as such or with a carrier. Carriers that can be used for the catalysts are any solid substances, which do not inhibit curing undesirably, or reduce transparency for photoactivation undesirably. The carrier can be solid or liquid. Solid carriers include for example silica, alumina, organic resins etc. Liquid carriers include polyorganosiloxanes, polyethers, solvents etc.

The photoactivatable catalyst is a catalyst, which provides sufficient pot life, i.e., processing time prior to gelling of the abovementioned components, once these have been combined.

Examples of photoactivatable catalysts include η-diolefin-σ-aryl-platinum complexes, such as disclosed in U.S. Pat. No. 4,530,879, EP 122008, EP 146307 (corresponding to U.S. Pat. No. 4,510,094 and the prior art documents cited therein), or US 2003-0199603, and also platinum compounds whose reactivity can be controlled by way for example using azodicarboxylic esters, as disclosed in U.S. Pat. No. 4,640,939 or diketonates.

Photoactivatable platinum compounds that can be used are moreover those selected from the group having ligands selected from diketones, e.g. benzoylacetones or acetylenedicarboxylic esters, and platinum catalysts embedded into photo-degradable organic resins. Other Pt catalysts are mentioned by way of example in U.S. Pat. No. 3,715,334 or U.S. Pat. No. 3,419,593. EP 1 672 031 A1 and Lewis. Colborn, Grade, Bryant, Sumpter, and Scott in Organometallics, 1995, 14, 2202-2213, all incorporated by reference here.

Photoactivatable catalysts can also be formed in-situ in the silicone composition to be shaped, by using Pt⁰-olefin complexes and adding appropriate photo-activatable ligands thereto.

Pt⁰-olefin complexes are prepared by way of example in the presence of 1,3 divinyltetramethyldisiloxane (M^{VI}₂) via reduction of hexachloroplatinic acid or of other platinum chlorides.

The photoactivatable catalysts that can be used here are, however, not restricted to these above mentioned examples.

Particularly preferred catalysts in view of high reactivity and cure rate include; (η⁵-cyclopentadienyl)-trialkyl-platinum complexes with (Cp=cyclopentadienyl) such as
(Cp)trimethylplatinum
(Cp)ethyldimethylplatinum
(Cp)triethylplatinum
(Cp)triallylplatinum
(Cp)tripentylplatinum
(Cp)trihexylplatinum
(methyl-Cp)trimethylplatinum
(trimethylsilyl-Cp)trimethyl platinum
(phenyldimethylsilyl-(Cp)trimethylplatinum
(Cp)acetyldimethylplatinum
(Cp)diethylmethylplatinum
(Cp)triisopropylplatinum
(Cp)tri(2-butyl)platinum
(Cp)triallyiplatinum
(Cp)trinonylplatinum
(Cp)tridodecylplatinum
(Cp)tricyclopentylplatinum
(Cp)tricyclohexylplatinum
(chlor)-Cp)trimethyl platinum
(fluoro-Cp)trimethylplatinum
(Cp)dimethylbenzylplatinum
(triethylsilyl-Cp)trimethylplatinum
(dimethylphenylsilyl-Cp)trimethylplatinum
(methyldiphenylsilyl-Cp)trimethylplatinum
(triphenylsilyl-Cp)trihexylplatinum
1,3-bis(trimethylsilyl)-Cp]trimethylplatinum
(dimethyloctadecylsilyl-Cp)trimethylplatinum
1,3-bis[(Cp)trimethylplatinum]tetramethyldisiloxane
1,3-bis[(Cp)trimethylplatinum]dimethyldiphenyfdisiloxane
1,3-bis[(Cp)dimethylphenylplatinum]tetramethyldisiloxane
1,3,5-tris[(Cp)trimethylplatinum]pentamethyltrisiloxane
1,3,5,7-tetra[(Cp)trimethylplatinum]heptamethyltetrasiloxane
(methoxy-Cp)trimethylplatinum
(ethoxymethyl-Cp)ethyldimethylplatinum
(methyoxycarbonyl-Cp)trimethylplatinum
(1,3-dimethyl-Cp)trimethylplatinum
(methyl-Cp)triisopropylplatinum
(1,3-diacetyl-Cp)diethylmethylplatinum
(1,2,3,4,5-pentachloro-Cp)trimethylplatinum
(phenyl-Cp)trimethylplatinum
(Cp)acetyldimethylplatinum
((Cp)propionyldimethylplatinum
(Cp)acrloyldimethylplatinum
(Cp)di(methacryloyl)ethylplatinum
(Cp)dodecanoyldimethylplatinum
trimethylplatinumcyclopentadienyl-terminated polysiloxane.

The most preferred photoactivatable catalysts to be used in the process of the invention are optionally alkyl or trialkylsilyl substituted cyclopentadienyl-tris-alkyl-platinum compounds, in particular, alkylcyclopentadienyl-trimethyl-platinum, in particular, methylcyclopentadienyl-trimethyl-platinum.

Further photoactivatable catalysts include (eta-diolefin)-(sigma-aryl)-platinum complexes (see e.g. U.S. Pat. No. 4,530,879) as exemplified in the following (wherein for the sake of simplification. “COD” signifies cyclooctadiene, “COT” signifies cyclooctatetraene, and “NBD” signifies norbornadiene):

### (1,5-COD)diphenylplatinum

### (1,3,5,7-COT)diphenylplatinum

### (2,5-NBD)diphenylplatinum

(3a,4,7,7a-tetrahydro-4,7-methanoindene)diphenylplatinum
(1,5-COD)-bis(4-methylphenyl)platinum
(1,5-COD)-bis(2-methylphenyl)platinum
(1,5-COD)-bis(2-methoxyphenyl)platinum
(1,5-COD)-bis(3-methoxyphenyl)platinum
(1,5-COD)-bis(4-phenoxyphenyl)platinum
(1,5-COD)-bis(4-methylthiophenyl)platinum
(1,5-COD)-bis(3-chlorophenyl)platinum
(1,5-COD)-bis(4-fluorophenyl)platinum
(1,5-COD)-bis(4-bromophenyl)platinum
(1,5-COD)-bis(4-trifluoromethylphenyl)platinum
(1,5-COD)-bis(3-trifluoromethylphenyl)platinum
(1,5-COD)-bis(2,4-bis(trifluoromethyl)phenyl)platinum
(1,5-COD)-bis(4-dimethylaminophenyl)platinum
(1,5-COD)-bis(4-acetylphenyl)platinum

### (1,5-COD)-bis(trimethylsilyloxyphenyl)platinum

### (1,5-COD)-bis(trimethylsilylphenyl)platinum

### (1,5-COD)-bis(pentafluorophenyl)platinum

(1,5-COD)-bis(4-benzylphenyl)platinum
(1,5-COD)-bis(1-naphthyl)platinum

### (1,5-COD)-naphthylphenylplatinum

(1,5-COD)-bis(2H-chromen-2-yl)platinum
(1,5-COD)-bis(xanthen-1-phenyl)platinum
(1,3,5-cycloheptatriene)diphenylplatinum
(1-chloro-1,5-COD)diphenylplatinum
(1,5-dichloro-1,5-COD)diphenylplatinum
(1-fluoro-1,5-COT)diphenylplatinum
(1,2,4,7-tetramethyl-1,3,5,7-COT)-bis(4-methylphenyl)platinum
(7-chloro-2,5-NBD)diphenylplatinum
(1,3-cyclohexadiene)diphenylplatinum
(1,4-cyclohexadiene)diphenylplatinum
(2,4-hexadiene)diphenylplatinum
(2,5-heptadiene)diphenylplatinum
(1,3-dodecadiene)diphenylplatinum
bis[η²-(2-propenyl)phenyl]platinum
bis[η²-2-(ethenylphenyl)]platinum
bis[η²-2-(cyclohexen-1-ylmethyl)phenyl]platinum.

Further photoactivatable catalysts include (η-diolefin) (α-alkyl)-platinum complexes, like

### (1,5-COD)Pt(methyl)₂

### (1,5-COD)Pt(benzyl)₂

### (1,5-COD)Pt(hexyl)₂.

The amount of component (iv) is preferably 0.1-1000 ppm, preferably 0.5-500 ppm, more preferably 1-100 ppm, particularly preferably 2-50 ppm, most preferably 2 to 20 ppm calculated as metal, based on the weight of components (i) to (iii).

The curing rate is inter alia determined by the selected catalyst compound, by its amount, and also by the nature and amount of an optionally present additional inhibitor component covered by components (vi).

### Filler

The silicone mixtures to be shaped and cured used according to the process of the invention moreover optionally comprise one or more, if appropriate surface-modified, fillers, components (v).

The fillers include by way of example all of the fine-particle fillers, i.e., those having particles smaller than 100 microns, i.e., preferably composed of such particles. These can be mineral fillers, such as silicates, carbonates, nitrides, oxides, carbon blacks, or silicas. The fillers are preferably those known as reinforcing silicas, which permit production of elastomers having better transparency, i.e., those which improve vulcanizate properties after crosslinking, and increase strength, examples being fumed or precipitated silica whose BET surface areas are from 50 to 400 m²/g, these preferably having been specifically surface-hydrophobicized here. If filler component (v) is used, its amounts are from 1 to 100 parts by weight, preferably from 10 to 70 parts by weight, even more preferably from 10 to 50 parts by weight, based on 100 parts by weight of component (i) and optionally (ii).

Fillers whose BET surface areas are above 50 m²/g permit production of silicone elastomers with improved vulcanizate properties. It is only above 90 m²/g that vulcanizate strength increases with, for example, fumed silicas, and these are therefore preferred, and even more preferred silicas are, for example, Aerosil® 200, 300, HDK® N20 or T30. Cab-O-Sil® MS 7 or HS 5 more than 200 m²/g BET surface area. As BET surface area rises, the transparency of the silicone mixtures in which these materials are present also rises. Examples of trade names of the materials known as precipitated silicas, or wet silicas, are Vulkasil® VN3, or FK 160 from Degussa, or Nipsil® LP from Nippon Silica K. K. and others.

Examples of materials serving as non-transparent fillers known as non-reinforcing fillers are powdered quartz, diatomaceous earths, powdered crystoballites, micas, aluminum oxides, aluminum hydroxides, Ti oxides, Fe oxides, Zn oxides, chalks, or carbon blacks whose BET surface areas are from 0.2 to 50 m²/g or higher if carbon black is used. These fillers are available under variety of trade names, examples being Sicron®, Min-U-Sil®, Dicalite®, Crystallite®. The materials known as inert fillers or extenders with BET surface areas below 50 m²/g should advantageously comprise no particles (<0.005% by weight) above 100 microns for use in silicone rubbers, in order that further processing generates no problems during downstream processing, e.g., passage through sieves or nozzles, or the mechanical properties of the articles produced therefrom are adversely affected. Among the opacifying fillers are also in particular non-transparent, in particular inorganic, pigments or carbon black.

The use of these opacifying fillers is preferred only when pigmentation is necessary or the physical function like thermal or electrical conductivity is a requirement.

As the person skilled in the art knows, a filler can also be a pigment. For clarification, the intention is that all of the inorganic pigments included in the term filler as component (v) for the present invention, whereas all of the remaining pigments and dyes, in particular organic dyes and stabilizers, be included in the definition of the auxiliaries (vi).

The fillers may be subject of any suitable conventional surface-treatment with suitable surface-treatment agents, such as hydrophobizing treatment with suitable hydrophobizing agent, dispersing treatment with suitable dispersing agents which influence the interaction of the filler with the silicone polymer, e.g., influence thickening action. The surface treatment of the fillers is preferably hydrophobation with silanes or with siloxanes. It can by way of example take place in situ via addition of silazanes, such as hexamethyldisilazane and/or 1,3-divinyltetramethyldisilazane, with addition of water, and in-situ hydrophobation is preferred. It can also take place with other familiar filler-treatment agents, for example with vinylalkoxysilanes, e.g., with vinyltrimethoxysilane, or with other silanes having unsaturated organofunctional groups, for example with methacryloxypropyltrialkoxysilanes, or else with poly-organosiloxanediols whose chain lengths are from 2 to 50 and which bear unsaturated organic radicals, with the aim of providing reactive sites for the crosslinking reaction. As explained above, however, for the purpose of the present invention the alkenyl-substituted polyorganosiloxanes used as hydrophobizing agent will be also subsumed under component (ii).

In order to establish examples of commercially available silicas pre-hydro-phobized with various silanes are: Arosil® R 972, R 974, R 976, or R 812, or, for example, HDK® 2000 or H30 Examples of trade names for materials known as hydrophobized precipitated silicas or wet silicas are Sipernat D10 or D15 from Degussa.

In one preferred embodiment, the silicone composition to be shaped according to the process of the invention comprises at least one reinforcing filler (v) which has at least a BET surface area of more than 50 m²/g, preferably more than 80 m²/g of BET surface area.

According to the invention, it is also possible to use a mixture of one or more, in particular two, tillers with different specific surface areas. Suitable selection of different, in particular two, fillers with different specific surface areas or treatment processes in order support the requirements of good forming or shaping properties, i.e., namely retaining high flowability at high level of green strength of unhardened polymer compositions and avoiding self-leveling of the continuously shaped articles. This can be achieved best by using fillers having preferably surface areas above 90 m²/g BET and a surface treatment with polyorganosiloxanediols, polyorganosiloxanes, chloro or alkoxysilanes which ensure a high degree of thickening properties, high viscosity level and shear thinning. Another assumption is a sufficient polymer viscosity. In addition one can increase the performance for effective forming or shaping by using specific auxiliary additives such as PTFE powders, PTFE emulsions or boron derivative in smaller amounts, i.e., below 1 wt. %.

### Conventional Additives

The auxiliary or conventional additives components (vi) can comprise for example organic dyes or pigments, stabilizers introduced in silicone rubbers in order to improve heat stability, i.e., resistance against hot air, reversion, such as i.e., depolymerisation under attack of traces of acids or water at high temperature. The auxiliary or conventional additives further include e.g. plasticizers, or release oils, or hydrophobicizing oils, such as polydimethylsiloxane oils, without reactive alkenyl or SiH groups, with viscosity which is preferably 0.001-10 Pa·s at 25 degrees C. Additional mold-release or flow improving agents can also be used, examples being fatty acid derivatives or fatty alcohol derivatives, fluoroalkyl surfactants. Compounds advantageously used here are those which separate rapidly and migrate to the surfaces. Stability after exposure to hot air can by way of example be increased using known hot-air stabilizers, such as Fe-, Mn-, Ti-, Ce- or La-compounds, and organic salts of these, preferably their organic complexes. Another class of the conventional additives (vi) are additives which can improve rheological properties, to provide higher flow and smooth surfaces of the shaped articles. Such additives are known for the persons skilled in the art and include PTFE-powders, boron oxide derivatives, flow additives like fatty acid derivative, esters and its salts or fluoroalkyl surfactants. The auxiliary additives may also include so-called inhibitors for controlling the crosslinking reaction and extending the pot life of the silicone composition. Examples of advantageous inhibitors include for example vinylsiloxanes, 1,3-divinyltetra-methyldi siloxane, or tetravinyl-tetramethyl-tetracyclosiloxanes (for sake of clarity it is pointed out that if inhibitors belong to the class of alkenyl polyorganosiloxanes they are formally subsumed under component (i) or (ii)). It is also possible to use other known inhibitors, for example ethynylcyclohexanol, 3-methylbutynol, or dimethyl maleate.

In an embodiment, the mixture to be shaped, in particular, to be calendered, comprising the components (i), (iii) and (iv) and optionally (ii), (v) and (vi), preferably has a viscosity of at least of at least 10 Mooney units, more preferably at least 15 Mooney units at room temperature (25 degrees C.). Mooney will be measured accordingly to DIN 53523 at 25 degrees C. as so-called MI₀=(starting value at time 0+15 see/max after 0 sec and MI₄=value 4 min after MI₀.

The present invention further is related to a novel composition, comprising:

(i) at least one polyorganosiloxane having at least three alkenyl groups and an average number of diorganosiloxy units determined by GPC with polystyrene as standard of at least 3000, and having in average less than 0.025 mol-% vicinal alkenyl groups, preferably less than 0.005 mol. %, the mol-% being based on integral of the ²⁹Si—NMR signal at −34.89 to −35.47 ppm related to the integral of the signals for all vinyl substituted Si atoms (P^{vinyl tot}=total concentration of Si vinyl atoms as described above),

(ii) optionally one or more polyorganosiloxanes having alkenyl groups, other than the polyorganosiloxane according to the component (i),

(iii) at least one polyorganosiloxane having at least two SiH groups,

(iv) at least one photoactivatable transition metal catalyst,

(v) optionally one or more filler,

(vi) optionally one or more conventional additives, which can be used, in particular, for the manufacture of continuously formed shaped articles.

Preferably such composition comprises the components (i) to (vi) in the amounts of components (i) to (vi) in the following amounts:

(i) 100 parts by weight,

(ii) 0 to 100 parts by weight, preferably 0 to 30 parts by weight,

(iii) 0.1 to 30 parts by weight, preferably 1 to 10 parts by weight,

(iv) 1 to 100 ppm, preferably 2 to 20 ppm. (referring to the amount of the transition metal in the photoactivatable transition metal catalyst in relation to the total amount of components (i) to (iii)),

(v) 0 to 100 parts by weight, preferably 15 to 60 parts by weight,

(vi) 0 to 15 parts by weight, preferably 0.01 to 10 parts by weight, which can be used for the manufacture of continuously formed shaped articles.

The shaped light-cured silicone compositions according to the invention can be used preferably in food and beverage industry, in medical care applications, in the electro and electronic industry, as glass fiber isolation, elastomer seal for or upon temperature sensitive substrates, etc.

Preferably a two-step mixing process is used, wherein in a first step a mixture is prepared with the components without the photoactivatable transition metal catalyst, and in a second mixing step the photoactivatable transition metal catalyst optionally together with other components is incorporated to prepare the photoactivatable mixture. During the incorporation of the photoactivatable transition metal catalyst and after the photoactivatable mixture is prepared, care must be taken for preventing premature cross-linking, which would make the subsequent forming or shaping difficult or even impossible. Premature cross-linking of the photoactivatable forming or shaping mixture can be prevented for example by using closed apparatus, or depending on the specific catalyst used, light of selected wavelength ranges. e.g., yellow light (600 to 650 nm) or red light (650 to 1000 nm). If light of selected wavelength ranges, which do not activate the photoactivatable transition metal catalyst, is used, of course open apparatus can be used, like two-roll mixers, etc.

In a preferred embodiment of the process of the invention, translucent mixtures are prepared, where the irradiation step is carried out after the final shaping, preferably calendering step. That is, such process usually includes a first step of mixing the mixture to be calendered, which may preferably include a separate step of admixture of the photoactivatable catalyst. In the second step the mixture obtained is fed into calender rolls. It is also in the scope of the invention to carry out a mixing step for the components of the mixture to be shaped directly in the shape-forming apparatus, preferably in the calendering device. It lies also in the ambit of the present invention to perform the mixing of all components of the mixture except for the photoactivatable catalyst in a conventional mixing unit such as a kneader, and to incorporate the photoactivatable catalyst in a shape-forming apparatus which has means for introducing additional components into the mixture to be shaped.

After the mixture has been formed it is discharged from the shaping apparatus and than passed on with suitable conveying means to an irradiation stage, wherein irradiation is carried out in order to activate the photoactivatable catalyst and to initiate the curing of the shaped silicone composition. Usually a heating step after the irradiation step is not required in order to complete curing, since the mixture is cured by the action of the photoactivated catalyst, but a heating step can be used additionally to shorten the curing time, if desired. Normally the silicone composition formed according to the process of the invention does not require higher temperatures during its manufacture, which is a particular advantage of the process of the invention, because it is energy saving, because it neither requires heating nor cooling means, and moreover, thermal shrinking of the shaped silicone composition can be almost completely avoided.

On the other hand, it is according to the invention normally not necessary to cool the shape-forming apparatus because the composition is not thermally sensitive, i.e., does not cure, before photoactivation of the catalyst through irradiation has been initiated. In particular on an industrial scale it represents a great advantage that the process of the present invention does not require cooling of the shape forming apparatus. However, in the specific case, where opaque fillers or pigments are used to prepare the shaped silicone articles with the process of the present invention, which requires an additional mixing step and the subsequent forming step after the irradiation step to activate the catalyst is carried out, it might be necessary to have the activated mixture cooled after the irradiation step to increase the scorch time of the mixture.

As the irradiation means in the process of the present invention, conventional irradiation units providing light whose wavelength is in the range of preferably from 180 to 600 nm, more preferably 190-500 nm, are used. If the light-activatable curable compositions comprise appropriate sensitizers or photoinitiators, selected from the class of anthracene, xanthonone, anthraquinone derivatives, then irradiation sources providing light of a wavelength range of 180 to 700 nm can also be used. The addition of commercially available sensitizers, such as benzophenones, etc., permits activation using longer-wavelength light or with better yields of light. As the irradiation sources preferably UV radiation sources are used for light-activation selected from xenon lamps which can be operated as flash lamps, undoped or iron- or gallium-doped mercury lamps, black-light lamps, excimer lasers and LEDs. The light-irradiation intensity (radiation dose*exposure time per unit of volume) is selected as a function of the selected process, of the selected composition of the temperature of the composition in such a way as to give a sufficient processing time. Commercially available irradiation sources may be used in the irradiation step of the present invention. Such irradiation sources may have power consumption of 0.5 to 20 kW and length of irradiation units of 5 cm to 1 m, which may be arranged in series of more than one irradiation unit to achieve increased exposure time. Additional reflectors radial assembled can help to increase the yield of light. The distance between shaped uncured composition and the light source is preferably between 1 cm to 100 cm.

Average exposure times (time which is required to pass the irradiation unit(s)) is for example at least 1 second, preferably 2 to 50 seconds.

Optionally useable additional heating means arranged after the irradiation unit may include conventional ones, i.e., hot air chambers, strip heaters, heat radiator units, heating mantles, etc.

Optionally the process is carried out with at least one conveying means, at least one packaging means and/or cutting means, for cutting the calendered composite into pieces.

A suitable silicone for use in the invention is commercially available from Momentive Performance Materials Inc. as a 50 durometer rubber compound containing methylvinyl siloxane polymer, fumed silica reinforcing filler, methylhydrogen polysiloxane crosslinker, and auxiliary ingredients per the teachings herein. With respect to the manufacture of septa, in a preferred process, the UV catalyst and optionally inhibitor is mixed into the silicone using a two roll mill. The catalyzed silicone is then calendered onto a PTFE backing sheet. Preferably, the surface of the PTFE sheet is modified, for example, by etching with a caustic agent such as sodium naphthalene. This creates surface irregularities which facilitate adherence of coatings. In a preferred embodiment a primer is first applied to the etched surface of the PTFE backing. A suitable primer for use in the invention contains both ethyl orthosilicate and tetra-n-butyl titanate in mineral spirits. Such a primer is commercially available from Momentive Performance Materials under the designation SS4155 primer.

The uncured calendered composite sheet is then exposed to UV radiation whereupon it is almost instantaneously cured.

Following this, the cured calendered sheet can then be slit into narrower rolls from which the septa are die punched, inspected, and packaged for sale.

The process of the invention requires fewer steps and less labor as compared to conventional thermally cured manufacturing processes. The curing is almost instantaneous with less energy consumption. The process can be conducted semi-continuously from calendering to septa formation while providing higher yield by eliminating or reducing out-gassing.

### EXAMPLE(S)

The following examples are presented herein for the purpose of illustrating the invention, and are not to be construed as limiting the scope of the invention.

### Example 1

A proposed cure process for calendered silicone rubber/PTFE sheet is exemplified by the following steps.

1. Momentive 50 durometer silicone rubber base was mill blended with 1% photoactive Pt-containing UV catalyst masterbatch.

2. An ⅛″ thick sheet of the catalyzed uncured silicone rubber was cold pressed onto a 4 mil thick etched Teflon film that had been surface modified with sodium naphthalene, which is identical to etched Teflon films currently used with thermally cured silicone rubber.

3. The uncured silicone rubber/Teflon composite was passed on a conveyor belt under a UV type “D” iron doped bulb at a distance of 5 inches from the silicone rubber surface using a Nordson CoolWave 2 UV system operated at 30% max power.

4. Belt speed was varied from 10 feet/minute to 20 feet/minute using either one or two consecutive passes under the UV light fixture.

5. The effect on adhesion of pre-priming the etched Teflon surface with SS4155 primer was also determined.

6. Subjective assessment of adhesion on a scale of 1 to 5 (1 no adhesion, 5 excellent adhesion) was determined as follows:

TABLE 1
Adhesion Of 50 Durometer UV Compound to Etched Teflon Film

| | A | B | C | D | E | F | G | H |
|---|---|---|---|---|---|---|---|---|
| Line Speed, ft/min. | 10 | 10 | 10 | 10 | 20 | 20 | 20 | 20 |
| # Passes | 1 | 1 | 2 | 2 | 1 | 1 | 2 | 2 |
| SS4155 Primer | No | Yes | No | Yes | No | Yes | No | Yes |
| Initial Adhesion | 2 | 5 | 2 | 5 | 2 | 4 | 2 | 5 |
| 24 Hour Adhesion | 3 | 5 | 3 | 5 | 3 | 5 | 3 | 5 |

Adhesion values were further quantified by running a standard 180 degree peel test at a crosshead speed of 2 inches/minute with the following results:

| Sample | Peel Strength, pounds/inch |
|---|---|
| 20 ft/min., 1 pass, no primer | 4 |
| 20 ft/min., 1 pass, SS4155primer | 11 |
| 10 ft/min., 1 pass, SS4155 primer | 11.4 |

### Observations:

The test data indicates that UV cured silicone rubber provides moderate adhesion to unprimed, etched PTFE Teflon film and excellent adhesion to primed, etched PTFE Teflon film. This discovery enables the use of UV cure as an improved method for producing calendered silicone rubber/PTFE Teflon composite sheet for the production of septa with the potential advantages as previously enumerated. In addition, other applications requiring adhesion of silicone rubber to PTFE such as multilayer tubing and molded matt seal closures may also benefit from this UV cure technology.

### Example 2

Calendered cured sheets of silicone/PTFE composite were made similar to the method of Example 1 except that the silicone included blue pigment. T-Peel tests were conducted. The results are set forth below in Table 2.

TABLE 2
UV CURED BLUE SILICONE RUBBER/ETCHED
TEFLON COMPOSITES, T-PEEL TEST RESULTS
All samples cured using Nordson Coolwave 2 at 30%
power with UV “D” iron bulb.

| Speed | | | | Primer | T-Peel |
|---|---|---|---|---|---|
| Ft/min. | # Passes | Inhibitor | SS4155 | Color | Value, lbs/in |
| 10 | 3 | Yes | Yes | Dark Blue | 12.2 |
| 10 | 3 | No | Yes | Dark Blue | 12.4 |
| 10 | 2 | Yes | Yes | Light Blue | 15.9 |
| 10 | 2 | No | Yes | Light Blue | 16.2 |
| 10 | 2 | Yes | No | Light Blue | 10.3 |
| 10 | 2 | No | No | Light Blue | 8.1 |
| 20 | 2 | Yes | No | Light Blue | 10.9 |

These results demonstrate the ability to UV cure and bond not only translucent rubber, as in Example 1, but also pigmented silicone as well.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A method for manufacturing a composite article of polytetrafluoroethylene and silicone comprising the steps of:
a) providing a UV-curable silicone;
b) applying the UV-curable silicone to a polytetrafluoroethylene backing; and
c) exposing the UV-curable silicone to UV radiation sufficient to cure the silicone.

2. The method of claim 1 wherein the step (a) of providing a UV-curable silicone comprises the combining of:
(i) at least one linear polyorganosiloxane having at least three alkenyl groups and an average number of diorganosiloxy units determined by GPC with polystyrene as standard of at least 3000,
(ii) optionally one or more polyorganosiloxane (ii) having alkenyl groups, other than the polyorganosiloxane according to the component (i),
(iii) at least one polyorganosiloxane (iii) having at least two SiH groups,
(iv) at least one photoactivatable transition metal catalyst,
(v) optionally one or more filler,
(vi) optionally one or more conventional additives, to provide an uncured silicone,

3. The method of claim 2 wherein linear polyorganosiloxane (i) has the general formula (I):
R₍₃₋ₓ₎R¹ₓSiO(R¹RSiO)ₐ(R₂SiO)_{b}SiR₍₃₋ₓ₎R¹ₓ (I),
in which x is preferably 0, 1, 2 or 3, a is an average value and is in the range of 0 to 100, b is an average value and is in the range of 3000 to 12000, with the proviso that the polydiorganosiloxane (i) of the general formula (I) has at least three alkenyl groups,
R=a saturated organic group,
R¹=an unsubstituted or substituted C₂-C₁₂-alkenyl radical selected from n-, iso-, tert-, or cyclic C₂-C₁₂-alkenyl, vinyl, allyl, hexenyl, C₆-C₃₀-cycloalkenyl, cycloalkenylalkyl, norbornenylethyl, limonenyl, C₈-C₃₀-alkenylaryl, in which, if appropriate, one or more —O— atoms can be present (corresponding to ether radicals) and the radicals can have substitution by one or more F-atoms.

4. The method of claim 3 wherein R is selected from n-, iso-, tert- or C₁-C₁₂-alkyl, C₁-C₁₂-alkoxy(C₁-C₁₂)alkyl, C₅-C₃₀-cycloalkyl or C₆-C₃₀-aryl, C₁-C₁₂-alkyl(C₆-C₁₀)aryl, each of these radicals R optionally having substitution by one or more F atoms and/or can contain one or more —O— groups, and R¹ is selected from vinyl, allyl, 5-hexenyl, cyclohexenylethyl, limonenyl, norbornenylethyl, ethylidenenorbornyl, and styryl.

5. The method of claim 3 wherein R is selected from methyl, phenyl, and 3,3,3-trifluoropropyl, and R¹ is vinyl.

6. The method of claim 3 wherein the step (a) comprises the combining of one or more polyorganosiloxane (ii) having alkenyl groups, other than the polyorganosiloxane according to the component (i), wherein the polyorganosiloxane (ii) has the formula
R₂R¹SiO(R₂SiO)ᵤSiR₂R¹ (II′),
in which the index ‘u’ is an average value and is in the range of 3000 to 12000, preferably 5000 to 11000, more preferably 6000 to 10000, and R and R¹ have the same meanings as given above for formula (I).

7. The method of claim 2 wherein the polyorganosiloxane (iii) has the formula
[Mₐ₂D_{b2}T_{c2}Q_{d2}R²ₑ₂]ₘ (III)
in which
M=R³R²SiO_{1/2},
D=R³RSiO_{2/2},
T=R³SiO_{3/2},
Q=SiO_{4/2}, in which
R=n-, iso-, tert- or C₁-C₁₂-alkyl, C₁-C₁₂-alkoxy(C₁-C₁₂)alkyl, C₅-C₃₀-cycloalkyl or C₆-C₃₀-aryl, C₁-C₁₂-alkyl(C₆-C₁₀)aryl, each of these radicals R optionally having substitution by one or more fluorine atoms and/or can contain one or more —O— groups,
R³=R, R¹ or hydrogen, with the proviso that at least two radicals R³ per molecule are hydrogen attached to a silicon atom, R being defined above,
R²=a divalent aliphatic n-, iso-, tert-, or cyclic C₁-C₁₄-alkylene radical, or a C₆-C₁₄-arylene or, respectively, alkylenearyl radical, which in each case bridges two siloxy units M, D or T,
m=from 1 to 1000
a2=from 1 to 10
b2=from 0 to 1000
c2=from 0 to 50
d2=from 0 to 1
e2=from 0 to 300.

8. The method of claim 7 wherein R is methyl and R¹ is vinyl.

9. The method of claim 7 wherein the polyorganosiloxne (iii) is selected from polyhydrogensiloxanes having structures corresponding to formula (IIIa-IIIf)
HR₂SiO(R₂SiO)₂(RHSiO)ₚSiR₂H (IIIa)
Me₂SiO(Me₂SiO)_{z}(MeHSiO)ₚSiMe₂H (IIIb)
Me₃SiO(Me₂SiO)_{z}(MeHSiO)ₚSiMe₃ (IIIc)
Me₃SiO(MeHSiO)ₚSiMe₃ (IIId)
{[R₂R³SiO_{1/2}]₀₋₃[R³SiO_{3/2}][R⁴O)ₙ₋₂}ₘ₂ (IIIe)
{[SiO_{4/2}][R⁴O_{1/2}][R₂R³SiO_{1/2}]_{0.01-10}[R³SiO_{3/2}]₀₋₅₀[RR³SiO_{2/2}]₁₀₀₀}ₘ₂ (IIIf)
where
z=from 0 to 1000
p=from 0 to 100
z+p=b4=from 1 to 1000
n2=from 0.001 to 4
m2=from 1 to 1000
in which R⁴O_{1/2} is an alkoxy radical on silicon, and R³ is defined as above.

10. The method of claim 2 wherein the at least one polyorganosiloxane (iii) comprises a mixture of a polyhydrogen siloxane (iii-1) selected from the group consisting of
HMe₂SiO-(Me₂SiO)_{z}SiMe₂H, and
Me₃SiO-(Me₂SiO)_{z}(MeHSiO)₂SiMe₃
[(Me₂SiO)_{z}(MeHSiO)₂].
and a polyhydrogen siloxane (iii-2) selected from the group consisting of
Me₃SiO-(MeHSiO)ₚSiMe₃,
HMe₂SiO(Me₂SiO)_{z}(MePhSiO)_{z}(MeHSiO)ₚSiMe₂H,
(MeHSiO)ₚ,
(HMe₂SiO)₄Si
MeSi(OSiMe₂H)₃,
in which p is from 0 to 100 and z is from 0 to 1000.

11. The method of claim 2 wherein the catalyst (iv) comprises a η⁵-(optionally substituted)-cyclopentadienyl platinum complex compounds having sigma-bonded alkyl ligands.

12. The method of claim 2 wherein the catalyst (iv) comprises one or more platinum complexes selected from the group consisting of:
(Cp)trimethylplatinum
(Cp)ethyldimethylplatinum
(Cp)triethylplatinum
(Cp)triallylplatinum
(Cp)tripentylplatinum
(Cp)trihexylplatinum
(methyl-Cp)trimethylplatinum
(trimethylsilyl-Cp)trimethyl platinum
(phenyldimethylsilyl-Cp)trimethylplatinum
(Cp)acetyldimethylplatinum
(Cp)diethylmethylplatinum
(Cp)triisopropylplatinum
(Cp)tri(2-butyl)platinum
(Cp)triallyiplatinum
(Cp)trinonylplatinum
(Cp)tridodecylplatinum
(Cp)tricyclopentylplatinum
(Cp)tricyclohexylplatinum
(chloro)-Cp)trimethyl platinum
(fluoro-Cp)trimethylplatinum
(Cp)dimethylbenzylplatinum
(triethylsilyl-Cp)trimethylplatinum
(dimethylphenylsilyl-Cp)trimethylplatinum
(methyldiphenylsilyl-Cp)trimethylplatinum
(triphenylsilyl-Cp)trihexylplatinum
1,3-bis(trimethylsilyl)-Cp]trimethylplatinum
(dimethyloctadecylsilyl-Cp)trimethylplatinum
1,3-bis[(Cp)trimethylplatinum]tetramethyldisiloxane
1,3-bis[(Cp)trimethylplatinum]dimethyldiphenyfdisiloxane
1,3-bis[(Cp)dimethylphenylplatinum]tetramethyldisiloxane
1,3,5-tris[(Cp)trimethylplatinum]pentamethyltrisiloxane
1,3,5,7-tetra[(Cp)trimethylplatinum]heptamethyltetrasiloxane
(methoxy-Cp)trimethylplatinum
(ethoxymethyl-Cp)ethyldimethylplatinum
(methyoxycarbonyl-Cp)trimethylplatinum
(1,3-dimethyl-Cp)trimethylplatinum
(methyl-Cp)triisopropylplatinum
(1,3-diacetyl-Cp)diethylmethylplatinum
(1,2,3,4,5-pentachloro-Cp)trimethylplatinum
(phenyl-Cp)trimethylplatinum
(Cp)acetyldimethylplatinum
(Cp)propionyldimethylplatinum
(Cp)acrloyldimethylplatinum
(Cp)di(methacryloyl)ethylplatinum
(Cp)dodecanoyldimethylplatinum
trimethylplatinumcyclopentadienyl-terminated polysiloxane.
(1,5-COD)diphenylplatinum
(1,3,5,7-COT)diphenylplatinum
(2,5-NBD)diphenylplatinum
(3a,4,7,7a-tetrahydro-4,7-methanoindene)diphenylplatinum
(1,5-COD)-bis(4-methylphenyl)platinum
(1,5-COD)-bis(2-methylphenyl)platinum
(1,5-COD)-bis(2-methoxyphenyl)platinum
(1,5-COD)-bis(3-methoxyphenyl)platinum
(1,5-COD)-bis(4-phenoxyphenyl)platinum
(1,5-COD)-bis(4-methylthiophenyl)platinum
(1,5-COD)-bis(3-chlorophenyl)platinum
(1,5-COD)-bis(4-fluorophenyl)platinum
(1,5-COD)-bis(4-bromophenyl)platinum
(1,5-COD)-bis(4-trifluoromethylphenyl)platinum
(1,5-COD)-bis(3-trifluoromethylphenyl)platinum
(1,5-COD)-bis(2,4-bis(trifluoromethyl)phenyl)platinum
(1,5-COD)-bis(4-dimethylaminophenyl)platinum
(1,5-COD)-bis(4-acetylphenyl)platinum
(1,5-COD)-bis(trimethylsilyloxyphenyl)platinum
(1,5-COD)-bis(trimethylsilylphenyl)platinum
(1,5-COD)-bis(pentafluorophenyl)platinum
(1,5-COD)-bis(4-benzylphenyl)platinum
(1,5COD)-bis(1-naphthyl)platinum
(1,5-COD)-naphthylphenylplatinum
(1,5-COD)-bis(2H-chromen-2-yl)platinum
(1,5-COD)-bis(xanthen-1-phenyl)platinum
(1,3,5-cycloheptatriene)diphenylplatinum
(1-chloro-1,5-COD)diphenylplatinum
(1,5-dichloro-1,5-COD)diphenylplatinum
(1-fluoro-1,3,5,7-COT)diphenylplatinum
(1,2,4,7-tetramethyl-1,3,5,7-COT)-bis(4-methylphenyl)platinum
(7-chloro-2,5-NBD)diphenylplatinum
(1,3-cyclohexadiene)diphenylplatinum
(1,4-cyclohexadiene)diphenylplatinum
(2,4-hexadiene)diphenylplatinum
(2,5-heptadiene)diphenylplatinum
(1,3-dodecadiene)diphenylplatinum
bis[η²-2-(2-propenyl)phenyl]platinum
bis[η²-2-(ethenylphenyl)]platinum
bis[η²-2-(cyclohexen-1-ylmethyl)phenyl]platinum.
(1,5-COD)Pt(methyl)₂
(1,5-COD)Pt(benzyl)₂
(1,5-COD)Pt(hexyl)₂;
wherein “Cp” signifies cyclopentadienyl, “COD” signifies cyclooctadiene, “COT” signifies cyclooctatetraene, and “NBD” signifies norbornadiene

13. The method of claim 2 wherein the catalyst (i) is, methylcyclopentadienyl-trimethyl-platinum.

14. The method of claim 2 wherein the UV curable silicone includes a filler (v) selected from silicates, carbonates, nitrides, oxides, carbon blacks, or silicas having a particle size of no more than 100 microns, the filler being present in an amount of from 1 to 100 parts by weight based on 100 parts by weight of component (i) and optionally (ii).

15. The method of claim 14 wherein the filler is fumed silica.

16. The method of claim 2 wherein the UV-curable silicone further comprises an additive (vi) selected from the group consisting of organic dyes or pigments, stabilizers plasticizers, polydimethylsiloxane oils, fatty acid derivatives or fatty alcohol derivatives, fluoroalkyl surfactants, organic salts or complexes of Fe-, Mn-, Ti-, Ce- or La-compounds, PTFE-powders, boron oxide derivatives, fluoroalkyl surfactants, 1,3-divinyltetra-methyldisiloxane, tetravinyl-tetramethyl-tetracyclosiloxanes ethynylcyclohexanol, 3-methylbutynol, and dimethyl maleate.

17. The method of claim 1 further including the step of modifying the surface of the polytetrafluoroethylene backing to which the UV-curable silicone is to be applied.

18. The method of claim 17 wherein the step of modifying the surface of the polytetrafluoroethylene backing comprises etching the surface with a caustic agent and applying a primer to the etched surface of the PTFE backing.

19. A composite article of polytetrafluoroethylene and silicone manufactured in accordance with the method of claim 1.

20. The composite article of claim 19 having a peel strength of at least 11 pounds/in as measured by running a standard 180 degree peel test at a crosshead speed of 2 inches/minute 72 hours after preparation of the composite.
